(19) United States
(12) Patent Application Publication
(10) Pub. No.: US 2007/0146912 A1
(43) Pub. Date: Jun. 28, 2007

(54) Blind spot reduction system

(76) Inventor: Michael A. Juska, Ann Arbor, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/318,916

(22) Filed: Dec. 27, 2005

(51) Int. Cl. G02B 5/10; G02B 7/182

(52) U.S. Cl. 359/868; 359/871

(57) ABSTRACT

An embodiment of a variable field of view mirror includes a reflective mirror portion defined, at least in part, by a reflecting surface selectively defining, with respect to a viewer, a visible frustum. The visible frustum has a viewing segment defining a predetermined arc taken normal to an axis. At least a portion of the reflecting surface is selectively deformable to increase the arc of the viewing segment.

### TECHNICAL FIELD

The technical field relates generally to mirrors and more specifically to rear and side view mirrors of a vehicle.

### BACKGROUND

A typical vehicle includes a plurality of mirrors. Generally, the operator may use these mirrors to view areas to the sides and rear of the vehicle during operation to relieve the operator the necessity of moving the head and/or eyes beyond a comfortable range of motion while driving.

FIG. 1 illustrates a roadway 20 from above (along a vertical axis) with a first vehicle 22 and a second vehicle 24 thereon. The first vehicle 22 includes conventional mirrors comprising a passenger's side mounted mirror 30, a centrally mounted mirror 32, and a driver's side mounted mirror 34. A driver 40 is operating the first vehicle 22. As viewed from above, the driver 40 has multiple viewing segments available in order to detect other objects on or near the roadway 20. The driver 40 has a frontal viewing segment 50 that is visible without the aid of a mirror, such as mirrors 30, 32 and 34, a passenger's side viewing segment 60 reflected in the passenger's side mounted mirror 30, a central viewing segment 62 reflected in the centrally mounted mirror 32, and a driver's side viewing segment 64 reflected in the driver's side mounted mirror 34.

As illustrated generally from above, viewing segments 50, 60, 62 and 64 are seen as portions of his environment that the driver 40 can perceive visually (field of view), although the viewing segments 50, 60, 62 and 64 may be obfuscated by various objects within sight of the driver 40 and limited by the visibility distance of the driver 40. Additionally, all viewing segments 50, 60, 62 and 64 illustrated do not reside in the same plane, as the driver's eyes, and mirrors 30, 32, 34 may be positioned at different vertical locations.

A typical human has a frontal visibility segment of about one-hundred ten degrees (110°) with the head stationary. For the driver 40, this visibility segment is increased to about one-hundred fifty degrees (150°) when the driver 40 rotates the head and/or eyes about a vertical axis approximately twenty degrees (20°) degrees to either side. Taking the head and eyes of the driver 40 as illustrated in FIG. 1, with a rotation of about twenty degrees to either side relative the vertical axis, as a normal driving orientation for the driver, the frontal viewing segment 50, the driver's side viewing segment 64, the passenger's side viewing segment 60, and the central viewing segment 62 are the visible segments of selected planes of view illustrated during a normal driving orientation. Generally, the plane of view for each mirror intersects the reflective surface and is used to simplify the discussion herein. Each plane of view is not necessarily parallel, and multiple planes of view are provided by the mirrors of a vehicle.

As illustrated two-dimensionally, there are a plurality of obscured viewing areas or blind spots 70 that the driver 40 may not see without moving the eyes and head beyond a 20° rotation. These obscured viewing areas 70 include an obscured region 72, located generally behind the driver between the driver's side viewing segment 64 and the central viewing segment 62; an obscured region 74 located between the passenger's side viewing segment 60 and the driver's side viewing segment 64; an obscured region 76 located between the driver's side viewing segment 64 and the frontal viewing segment 50; and an obscured region 80 located between the passenger's side viewing segment 60 and the frontal viewing segment 50.

The obscured viewing areas 70 may include other areas that are blocked by items such as passengers, opaque vehicle components, and cargo within the line of sight of the driver 40. That is, cargo within the vehicle intersecting the line of sight between the driver 40 and the second vehicle 24 may prohibit the driver from seeing the second vehicle 24 even if the driver were to rotate his head toward the second vehicle 24.

As illustrated, the second vehicle 24 may be completely within the obscured region 80. That is, the driver 40 may not see the second vehicle 24 without moving the head and/or eyes beyond a normal driving orientation.

While these mirrors may perform adequately for their intended purposes, a mirror that could reduce the obscured viewing areas, or blind spots, would provide a driver with an increased field of view while not requiring that the driver move the head and/or eyes beyond a normal driving orientation.

### SUMMARY

An embodiment of a variable field of view mirror includes a reflective mirror portion defined, at least in part, by a reflecting surface selectively defining, with respect to a viewer, a visible frustum. The visible frustum has a viewing segment defining a predetermined arc taken normal to an axis. At least a portion of the reflecting surface is selectively deformed to increase the arc of the viewing segment.

In a further embodiment, a blind spot reduction system includes a flexible mirror element having a reflecting surface. The mirror element is selectively defined, at least in part, by a surface portion of generally constant curvature. The system further includes a control system for changing the orientation of at least a first portion of the reflecting surface relative at least a second portion of the reflecting surface.

In another embodiment, a method of increasing a vehicle driver's viewing field includes providing a mirror having a reflective surface. The reflective surface, in a first configuration, defines a first viewing frustum for a viewer. The reflective surface, in a second configuration, defines a second viewing frustum for the viewer. The reflective surface may be deformed to deform the viewing frustum.

### BRIEF DESCRIPTION OF THE DRAWINGS

FIG. 1 is a view of a vehicle from above, illustrating a prior-art field of view.

FIG. 2 is a view of a vehicle from above, illustrating a field of view according to an embodiment.

FIG. 3 is a partial perspective view of the vehicle of FIG. 2, illustrating a rear view mirror according to an embodiment.

FIG. 4 is an enlarged partial top plan view taken along line 114 of FIG. 3.

FIG. 4A is an enlarged view of area 4A of FIG. 4.

FIG. 5 is an enlarged partial top plan view similar to FIG. 4, and illustrating the mirror in a different configuration.

FIG. 6 is an enlarged partial end view taken along line 6-6 of FIG. 5, with the mirror portion removed for clarity.

FIG. 7 is a perspective view of a viewing cone of an exemplary human eye.

FIG. 8 is a perspective view of an exemplary viewing frustum, not to scale and not necessarily proportional, provided to a viewer by an exemplary mirror.

FIG. 9 is a schematic top plan view of a mirror of an embodiment illustrated in a first configuration with a control apparatus omitted for clarity.

FIG. 10 is a schematic top plan view of the mirror of FIG. 9 illustrated in a second configuration with a control apparatus omitted for clarity.

FIG. 11 is a side view of a reflective surface of an embodiment illustrated in one configuration.

FIG. 11A is an enlarged view of area 11A of FIG. 11.

FIG. 12 is a side view of the reflective surface of FIG. 11 illustrated in another configuration.

### DETAILED DESCRIPTION

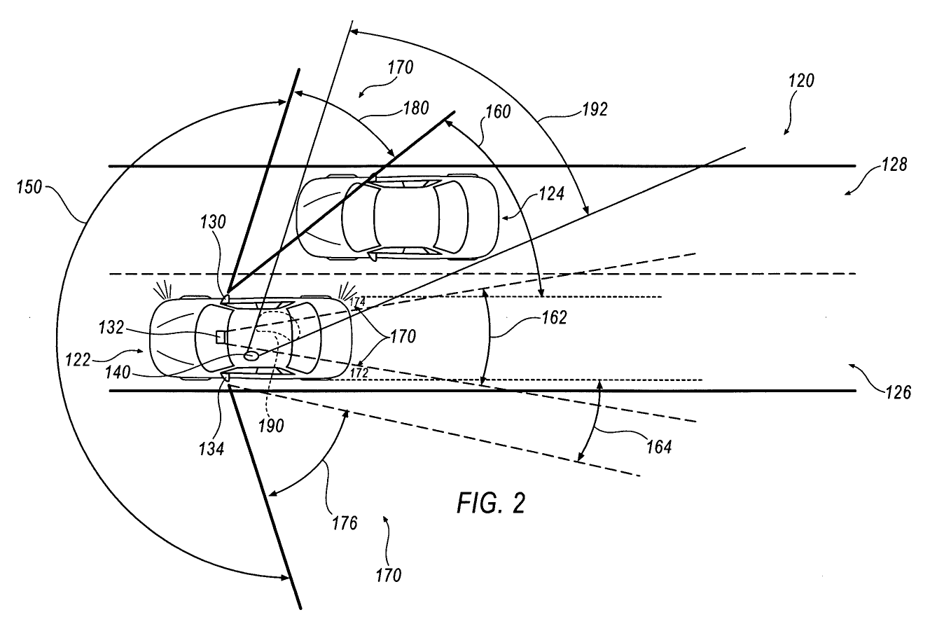

FIG. 2 illustrates a roadway 120 along a vertical axis with a first vehicle 122 and a second vehicle 124 thereon. The roadway 120 includes a first lane 126 and an adjacent lane 128. The first vehicle 122 is traveling generally in the first lane 126, and the second vehicle is traveling generally in the adjacent lane 128. The first vehicle 122 includes a passenger side mounted mirror 130, a centrally mounted mirror 132, and a driver side mounted mirror 134. A driver 140 is operating the first vehicle 122. As viewed from above, the driver 140 has multiple viewing segments available in order to detect other objects on roadway 120. The driver 140 has a frontal viewing segment 150 that is visible without the aid of a mirror, such as mirrors 130, 132, and 134. The driver 140 has a passenger side viewing segment 160 reflected in the passenger side mounted mirror 130, a central viewing segment 162 reflected in the centrally mounted mirror 132 and a driver side viewing segment 164 reflected in the driver's side mounted mirror 134.

As illustrated two-dimensionally, there are a plurality of obscured viewing areas, or blind spots 170 located outside of the first vehicle 122 that the driver 140 cannot see without moving the eyes and head beyond a 20 degree rotation. These obscured viewing areas 170 include an obscured region 172, located generally behind the driver between the driver side viewing segment 164 and the central viewing segment 162; an obscured region 174 located between the passenger side viewing segment 160 and the central viewing segment 162; an obscured region 176 located between the driver side viewing segment 164 and the frontal viewing segment 150; and an obscured region 180 located between the passenger side viewing segment 160 and the frontal viewing segment 150.

As illustrated from the position of the driver 140, the second vehicle 124 cannot fit within the obscured region 180 while in the adjacent lane 128. Therefore, the driver 140 can visually detect the second vehicle 124 without moving the head and/or eyes beyond a normal driving orientation.

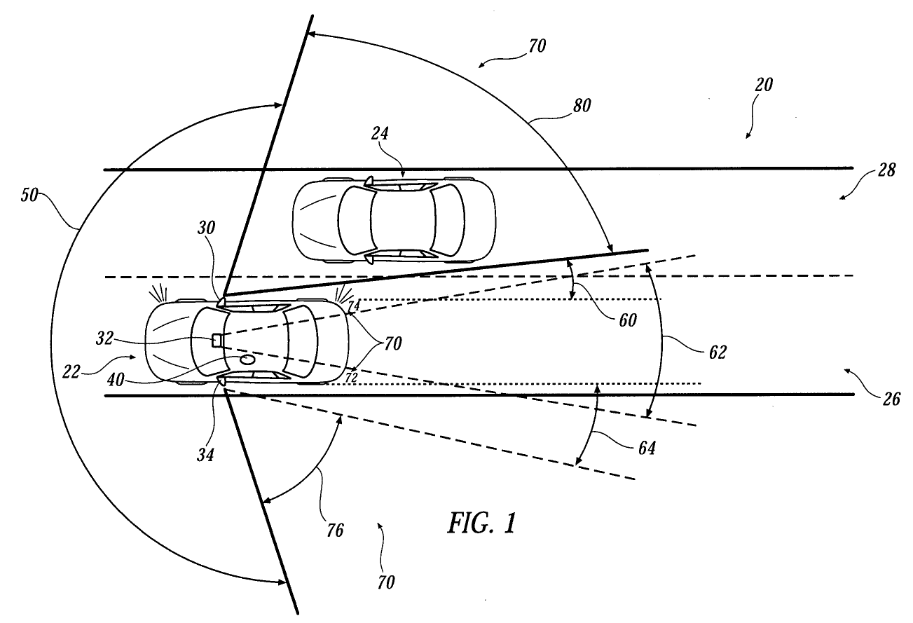

As in FIG. 1, FIG. 2 illustrates the multiple fields of view (as multiple segments within multiple planes that are not necessarily parallel) available to a driver taken generally normal to the vertical axis, and not necessarily the actual field of view, which may be obscured by an obstruction 190, such as sunlight, passengers, cargo, opaque vehicle components and the like. The exemplary obstruction 190 creates an obscured region 192 that encompasses the second vehicle 124. Therefore, even if the driver 140 were to rotate the head and/or eyes sufficiently to have the second vehicle 124 within the line of sight, the second vehicle 124 would not be visually detected by the driver 140 due to the positioning of the obstruction 190. Accordingly, the increased field of view of the passenger side viewing segment 160 provided by the mirror 130 may permit the driver 140 to visually detect the second vehicle 124 even when a direct line of sight is obscured.

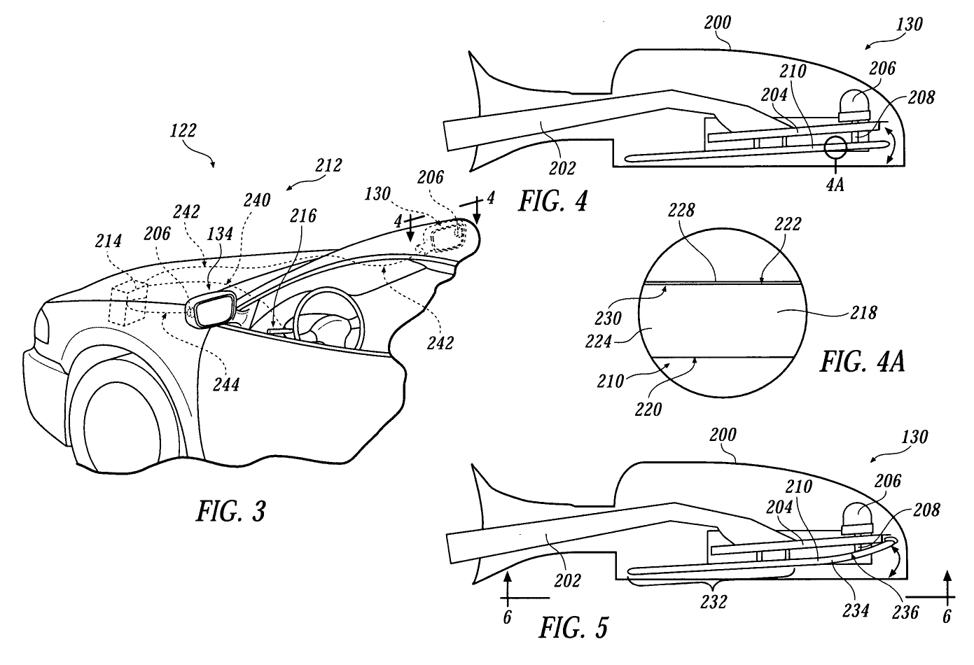

FIGS. 3-6 illustrate an embodiment of the passenger side mounted mirror 130. As best seen in FIGS. 4-6, mirror 130 includes a housing 200, a support arm 202, a mounting base 204, a deformation device 206 having a linearly moveable plunger 208, and a mirror portion 210. Collectively, a mirror system 212 is illustrated as including the mirror 130, a control unit 214, and a turn signal 216 (FIG. 3). The mirror portion 210 is secured to the mounting base 204. The mounting base 204 is adjustably coupled to the support arm 202. The control unit 214 is capable of pivoting the mirror portion 210 relative to the housing 200 in order to adjust the mirror 130 for individual drivers, such as driver 140.

The deformation device 206 is coupled to the mounting base 204, and the plunger 208 is coupled to the mirror portion 210. The deformation device 206 is operable to linearly displace the plunger 208 at least between a first position, illustrated in FIG. 4, and a second position, illustrated in FIG. 5, as discussed in greater detail below.

As best seen in FIG. 4A, mirror portion 210 includes a generally transparent body 218 having a first, or outer, surface 220 an inner surface 222, and a peripheral edge 224. In the embodiment illustrated, the inner surface 222 has a reflective coating 228 applied thereto, which provides a reflective surface 230.

Referring to FIGS. 4 and 5, the embodiment of mirror portion 210 illustrated includes a generally stable portion 232 and a deformable mirror portion 234 having a deformable reflective surface 236 attached thereto. As discussed in greater detail below, at least the deformable mirror portion 234 may be curved to distort the reflective surface 230, thereby increasing the visually detected field of view for a driver 140 who remains in a generally constant orientation relative to the mirror 130.

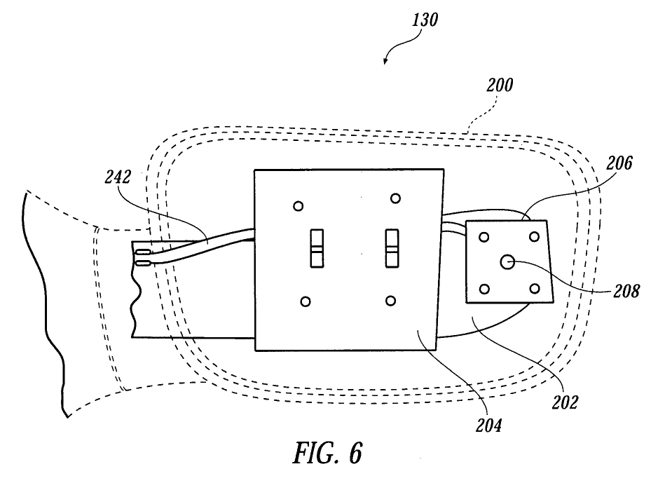

With reference to FIGS. 3 and 6, the mirror system 212 is illustrated to further include a connector 240, a connector 242, and a connector 244. The connector 240 operably interconnects the turn signal 216 with the control unit 214 for the transmission of signals therebetween. The connector 242 operably interconnects the deformation device 206 of the mirror 130 and the control unit 214 for the transmission of signals therebetween. The connector 244 operably interconnects the deformation device 206 of the mirror 134 and the control unit 214 for the transmission of signals therebetween.

The mirror system 212 may not have a control unit 214, but may operate to actuate the deformation device 206 upon actuation of the turn signal 216 by the driver 140. That is, manual operation of the turn signal 216 may automatically provide a signal, or power, to the deformation device 206. Actuation of the deformation device 206 may be via electrical signal or other energy transfer means or mechanisms.

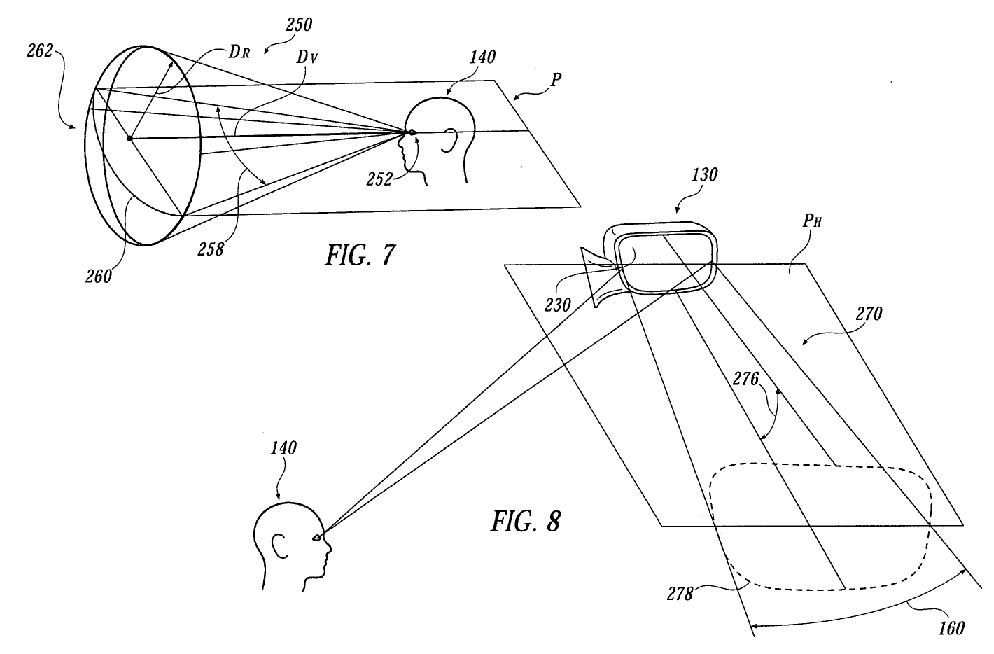

To more clearly describe the operation of the mirror 130, FIG. 7 generally illustrates a viewing cone 250 for an eye 252 of the driver 140. The viewing cone 250, observed in a 2-dimensional view intersecting a plane P that bisects the viewing cone 250, defines a viewing segment 258. Generally, a visibility distance D_{V} that a viewer V, such as the driver 140 may see, defines a viewing arc 260 along the plane P. Thus illustrated, the eye 252 has a visible viewing volume defined by the right circular viewing cone 250 and a hemi-spherical portion 262. The hemispherical portion 262 is defined by the hemispherical volume of a sphere of radius D_{R} that intersects the generally circular base of the viewing cone 250. Generally, a viewer such as the driver 140, will see only a portion of the objects within the viewing cone 250, as objects that are seen by the viewer limit visual detection of other objects.

FIG. 8 illustrates a visibility frustum 270 created by the light impinging on a reflective surface, such as the reflective surface 230. As illustrated, the visibility frustum 270 is defined by the viewing segment 160 (FIG. 2), which may be generally horizontal taken along horizontal plane P_{H}, and a viewing segment 276, which may be generally vertical. A plane parallel to at least a portion of the reflective surface 230, and intersecting the visibility frustum 270 will generally define an outer periphery 278 of the visibility frustum 270 that is generally the same shape as the peripheral edge 224, while being proportionally larger than the peripheral edge 224.

When the viewer is not within the visibility frustum 270, as illustrated in FIG. 8, the viewer, such as the driver 140, can see, or visually detect, the closest portions of objects in direct line of sight, up to a maximum visibility distance. The maximum visibility distance may depend upon lighting and diffraction within the visibility frustum 270. Diffraction may be caused by suspended particles in the air, such as dust or fog, or by glare. Generally, a viewing segment may be expressed in degrees of a circle, whether the segment is a complete arcuate section of a circle or a frusto-segment, as is provided by a reflective surface, such as reflective surface 230. As discussed herein, the visibility cone 250 is detected by a single eye, while the visibility volume for a viewer using two eyes is actually two visibility cones that overlap.

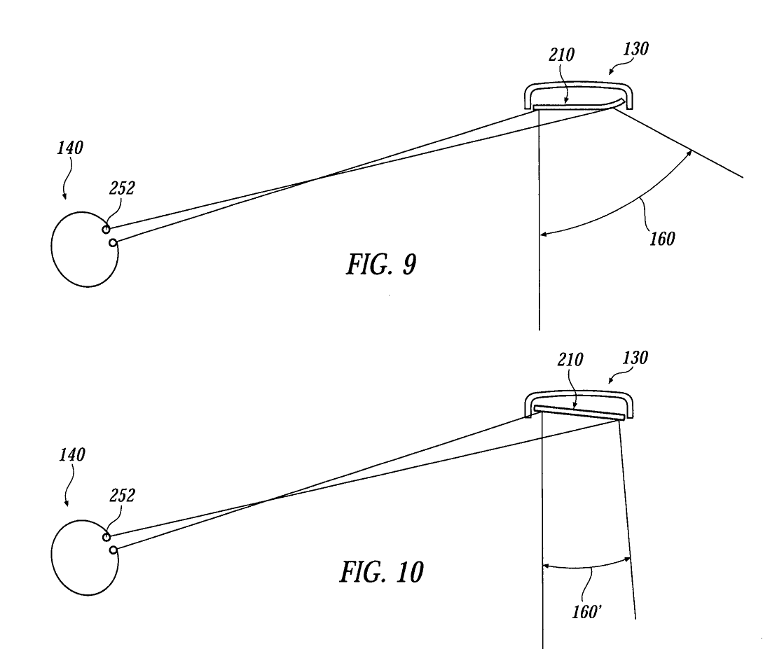

FIGS. 9 and 10 illustrate the mirror 130 in various configurations with respective viewing segments. FIGS. 5 and 9 illustrate the mirror 130 in a first configuration, with the deformable mirror portion 234 deformed in a generally curved contour such that the viewing segment seen by the driver 140 is the viewing segment 160 as in FIG. 2. FIGS. 4 and 10 illustrate the mirror 130 in a second configuration, with the deformable mirror portion 234 deformed in a generally flat contour such that the viewing segment seen by the driver 140 is a viewing segment 160′. As illustrated, the viewing segment 160′ has a smaller arcuate width than the viewing segment 160 and may be similar to the prior-art viewing segment 60 (FIG. 1). As will be appreciated, as the driver 140 moves relative to the mirror portion 210, the viewing segment seen, such as the viewing segment 160, may vary in direction and arcuate width.

FIGS. 9 and 10 illustrate two potential configurations and viewing segments, although a plurality of configurations for mirror portion 210 are anticipated. Specifically, the mirror portion is selectively deformable to provide a range of configurations including the first configuration of FIG. 9 and the second configuration of FIG. 10.

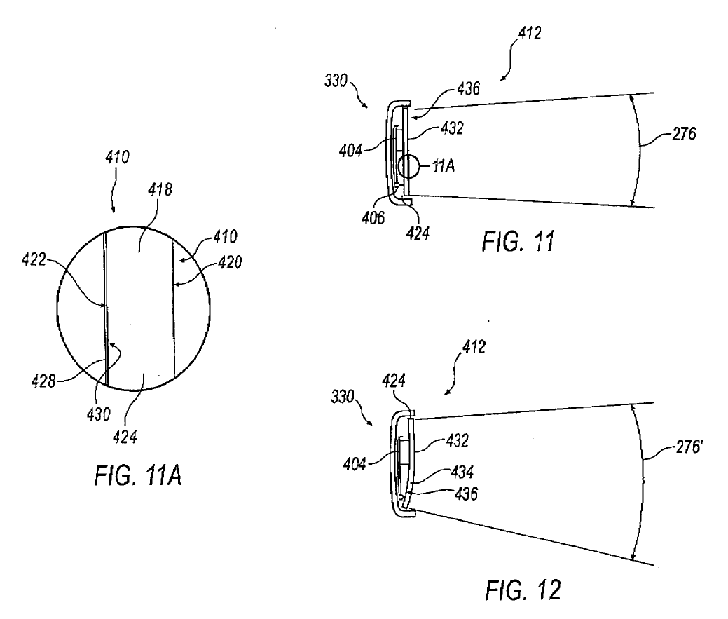

FIGS. 11 and 12 illustrate an embodiment of the mirror 130 as mirror 330. Mirror 330 includes a housing 400, a support arm 402, a mounting base 404, a deformation device 406, and a mirror portion 410. Collectively, a mirror system 412 includes the mirror 330, the control unit 214, and an input device (not shown), such as a sensor to detect when the first vehicle 122 is attempting to operate in reverse. The mirror portion 410 is secured to the mounting base 404. The mounting base 404 is adjustably coupled to the support arm 402. The control unit 214 is capable of pivoting the mirror portion 410 relative to the housing 400 in order to adjust the mirror 330 for individual drivers, such as driver 140.

As best seen in FIG. 11A, mirror portion 410 includes a generally transparent body 418 having a first or outer surface 420, an inner surface 422, and a peripheral edge 424. In the embodiment illustrated, the inner surface 422 has a reflective coating 428 applied thereto, which defines a reflective surface 430. The embodiment of mirror portion 410 illustrated includes a generally stable portion 432 and a deformable mirror portion 434 having a deformable reflective surface 436 attached thereto. The embodiment of mirror portion 410 illustrated includes a generally stable portion 432 and a deformable mirror portion 434 having a deformable reflective surface 436 attached thereto.

FIGS. 11 and 12 illustrate the mirror 330 in various configurations with respective viewing segments. FIG. 12 illustrates the mirror 330 in a first configuration, with the deformable mirror portion 434 deformed in a generally curved contour such that the viewing segment seen by a viewer (not shown) is the viewing segment 276′. FIG. 11 illustrates the mirror 330 in a second configuration, with the deformable mirror portion 434 deformed in a generally flat contour such that the viewing segment seen by a viewer (not shown) is the viewing segment 276 (FIG. 8). As illustrated, the viewing segment 276 has a smaller arcuate width than the viewing segment 276′. As will be appreciated, as a viewer, such as the driver 140, moves relative to the mirror portion 430, the viewing segment seen, such as the viewing segment 276, will vary in direction and arcuate width.

One method of manufacturing the mirror portion 210, 410 is to provide a flexible transparent body 218, 418 with a flexible reflective coating 228, 428. The mirror portion 210, 410 may be flexible in the deformable mirror portion 234, 434, and not flexible in the stable portion 232, 432. The stable portion 232, 432 is attached to the mounting base in secure fashion to retain the stable portion 232, 432 in a generally constant contour. The deformable mirror portion 234, 434 is coupled to the plunger 208. As best seen in FIGS. 4 and 5, the deformation device 206 is a linear mover that urges the transparent body 218 of mirror portion 210, via the interconnection of the plunger 208, to deflect at least the deformable mirror portion 234, 434.

An embodiment of the operation of the mirror system 212 is as follows. The driver 140, upon deciding to direct the first vehicle from the first lane 126 to the adjacent lane 128, manually actuates the turn signal 216. The control unit 214 detects the operation of the turn signal 216 and sends a signal to the deformation device 206 to linearly move the plunger 208. The plunger 208 deforms the mirror portion 210 from the second configuration of FIGS. 4 and 10, to the first configuration of FIGS. 2, 5 and 9 by moving at least part of the deformable mirror portion 234 toward the support arm 202. That is, at least part of the deformable mirror portion 234 is moved toward the front of the first vehicle 122 (in the direction of arrow F of FIG. 2). When in the first configuration, the mirror portion 210 permits the driver 140 to visually detect the viewing segment 160, which may allow the driver 140 to see the second vehicle 24, or alternatively, to see that there is no vehicle occupying the adjacent lane 128 within the viewing segment 160.

Operation of the mirror 330 is similar to the operation of the mirror 130, with the mirror portion 410 deformable when the first vehicle 122 is placed in reverse. The increased viewing segment 276′ may permit the driver 140 to see objects (not shown) before and during operation of the first vehicle 122 in reverse. These objects may include a curb (when parallel parking) the edge of a roadway, or objects that may damage the vehicle if impacted.

While the increase in the visible frustum 270 with the mirror 130 of FIG. 2 is illustrated as two-dimensional in the foregoing discussion, with the segments of the possible 360° viewing area visible to a viewer, such as the driver 140 described, it should be appreciated that the visible frustum for the driver is a three-dimensional volume that defines the two-dimensional viewing segment 160 at the intersection of the visible frustum 270 and the plane P_{H}. Additionally, the visible frustum 270 may be increased in the vertical dimension, as illustrated in FIG. 12 and the horizontal dimension, as illustrated in FIG. 9, simultaneously, thereby providing an increased three dimensional visible frustum.

While any amount of rotation of the head and/or eyes of the driver 140 may be normal, one would appreciate that the mirrors described herein will aid the driver 140 to see objects, such as the second vehicle 124, otherwise undetectable by the driver 140, whether the vehicle is in a blind spot 170 created by the positioning of a limited number of mirrors, or an obstruction, such as the obstruction 190.

As illustrated, the mirror system 212 would also be an aid to a driver, such as the driver 140, who is operating a vehicle with the side view mirrors and eyes in an orientation that does not provide an optimum visibility frustum for detecting objects, such as adjacent vehicles, as when a driver adjusts his seat or moves his head during driving, or when the side view mirror is not optimally adjusted for the driver.

The outer surface 220 of the mirror 130 may be generally flat or may have a slightly convex contour. Also, the mirror 130 may have a reflecting surface 230 that is the outer surface 220 of the mirror portion 210, or the mirror portion 210 may be a conventional mirror as described. Additionally, the mirror portion 210 and/or the reflective coating 228 may be a plurality of portions that may deform or may be oriented relative to one another at desired variable angles to produce the distortion of the visible frustum 270 described herein.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

1. A variable field of view mirror assembly for a vehicle comprising:
a reflective mirror defined, at least in part, by a reflecting surface selectively defining, with respect to a viewer, a visible frustum with a viewing segment selectively defining a predetermined arc taken normal to an axis, wherein at least a portion of the reflecting surface is selectively deformable to increase the arc of the viewing segment; and
a control system for changing an orientation of at least a first portion of the reflecting surface relative to at least a second portion of the reflecting surface, wherein the reflecting surface is selectively deformable in response to a generally linear movement directed by the control system, and the generally linear movement is applied to the first portion and applied in a direction generally normal to the second portion.

2. The assembly of claim 1, wherein the reflecting surface is selectively defined by a generally planar portion and a curved portion.

3. The assembly of claim 2, wherein the generally planar portion defines a larger surface area than the curved portion.

4. The assembly of claim 1, wherein the reflecting surface is a continuous outer surface.

5. (canceled)

6. The assembly of claim 1, wherein the reflecting surface is selectively deformable in response to a manual input by a vehicle operator.

7. The assembly of claim 1, wherein the at least a portion of the reflecting surface is selectively deformable at least partially concurrently with a vehicle turn signal.

8. A blind spot reduction system comprising:
a mirror element having a reflecting surface and selectively defined, at least in part, by a surface portion of generally constant curvature, wherein the reflecting surface defines a plurality of viewing frustums for a user; and
a control system for changing an orientation of at least a first portion of the reflecting surface relative at least a second portion of the reflecting surface, wherein the control system selectively changes the curvature of at least a portion of the reflective surface to increase a vertical arc of a viewing segment as observed by a viewer.

9. The system of claim 8, wherein the reflecting surface is a continuous surface.

10. The system of claim 8, wherein the reflecting surface is selectively deformable in response to a generally linear movement, and the generally linear movement is applied in a direction generally normal to the second portion.

11. The system of claim 8, wherein the reflecting surface is selectively deformable in response to a manual input by a vehicle operator.

12. The system of claim 8, wherein the reflecting surface is selectively generally planar.

13. (canceled)

14. The system of claim 8, further comprising a deformation device selectively operably coupled to the control system and the mirror element, wherein the deformation device selectively directs energy to the mirror element to deform a portion of the mirror element.

15. The system of claim 14, wherein the deformation device is positioned outside a vehicle.

16. The system of claim 14, further comprising a support arm attached the second portion and the deformation device, wherein the deformation device is coupled to the first portion.

17. The system of claim 8, wherein at least a portion of the first portion is selectively moved toward the front of the vehicle.

18. A method of increasing a vehicle driver's viewing field comprising:
providing a mirror having a reflective surface and defining a viewing frustum with respect to a viewer, wherein the reflective surface, in a first configuration, defines a first viewing frustum for the viewer, and the reflective surface, in a second configuration, defines a second viewing frustum for the viewer, wherein the reflective surface may be selectively deformed between a first preselected configuration and a second preselected configuration to deform the viewing frustum, wherein the reflecting surface is selectively deformable in response to a generally linear movement, and the linear movement is applied in a direction generally normal to the reflective surface.

19. The method of claim 18, further comprising deforming the reflective surface to deform the viewing frustum, wherein the first viewing frustum is defined by a generally vertical first viewing segment and the second viewing frustum is defined by a generally vertical second viewing segment, and wherein the second viewing segment is defined by a greater arc than the first viewing segment.

20. The method of claim 19, further comprising actuating a deformation device, wherein the actuation of the deformation device, at least in part, causes the deforming of the reflective surface.

21. The method of claim 20, wherein actuating is performed in response to a manual input.

22. The method of claim 18, wherein the second viewing frustum is larger than the first viewing frustum.

23. The method of claim 18, further comprising providing a deformation device, wherein the deformation device selectively, at least in part, deforms at least a portion of the reflective surface.

24. The method of claim 18, wherein the first viewing frustum is defined, at least in part, with the viewer is in generally a predetermined location relative the reflective surface, and the second viewing frustum is defined, at least in part, with the viewer is generally in the predetermined location relative the reflective surface.

25. The system of claim 8, wherein the control system selectively changes the curvature of at least a portion of the reflective surface in response to a detected desired operation of a vehicle in reverse.

26. The assembly of claim 1, wherein the control system selectively changes the curvature of at least a portion of the reflective surface to increase a vertical arc of a viewing segment as observed by a viewer.

27. The assembly of claim 1, wherein the control system selectively changes the curvature of at least a portion of the reflective surface to increase a horizontal arc of a viewing segment as observed by a viewer.
